(19) United States
(12) Patent Application Publication
(10) Pub. No.: US 2002/0049019 A1
(43) Pub. Date: Apr. 25, 2002

(54) Methods for improving brightness of fabrics and fabrics of improved brightness

(75) Inventors: Victoria Anne Maxfield, Hamilton, OH (US); Michelle Frances Mellea, Hamilton, OH (US); George L. Payet, Cincinnati, OH (US); Lori Joanne Walker, Loveland, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/821,311

(22) Filed: Mar. 29, 2001

Related U.S. Application Data
(60) Provisional application No. 60/192,815, filed on Mar. 29, 2000.

(51) Int. Cl. B32B 27/12; B32B 27/04; B32B 27/20; B32B 5/02; B32B 9/04

(52) U.S. Cl. 442/130; 442/152; 442/153

(57) ABSTRACT

Methods for improving the brightness and durable press properties of fabric comprise treating the fabric with an aqueous solution comprising formaldehyde, catalyst for crosslinking the formaldehyde with natural fibers in the fabric, and silicone elastomer or precursor thereof, and heating the treated fabric to react the formaldehyde with natural fibers in the fabric. Methods for improving the brightness and shrinkage resistance properties of fabric comprise treating the fabric with an aqueous solution comprising formaldehyde, catalyst for crosslinking the formaldehyde with natural fibers in the fabric, and silicone elastomer or precursor thereof, and heating the treated fabric to react the formaldehyde with natural fibers in the fabric. Cellulose fabric which has a crosslinked formaldehyde durable press treatment and has been subjected to laundering with a brightener-containing detergent exhibits enhanced brightness after the laundering. Cellulose fabrics having a crosslinked formaldehyde treatment exhibit enhanced brightness after home laundering.

### CROSS REFERENCE TO RELATED APPLICATIONS

This application claims priority under 37 U.S.C. § 119(e) to U.S. Provisional Application Serial No. 60/192,815, filed Mar. 29, 2000 (Attorney Docket No. 8007P).

### FIELD OF THE INVENTION

This invention relates to methods for improving the brightness of fabrics containing natural fibers, particularly while providing good durable press properties and/or shrinkage resistance. This invention also relates to fabrics having a crosslinked formaldehyde durable press or shrinkage resistance treatment and exhibiting enhanced brightness after laundering.

### BACKGROUND OF THE INVENTION

Many fabrics, particularly fabrics comprising natural fibers, do not possess durable press (or “wash and wear” or “smooth-dry”) performance and/or dimensional stability, i.e., shrinkage resistance. Cellulosic fabrics have been treated with aminoplast resins, including N-methylol cross-linking resins such as dimethylol dihydroxyethyleneurea (DMDHEU) or dimethylol propylcarbamate (DMPC), to impart durable press properties. For example, the Martin et al U.S. Pat. No. 4,521,176 discloses a textile finishing composition comprising a diluent and a durable press resin composition containing an aminoplast resin and an aldehyde in excess of that present in the aminoplast resin. Martin et al further teach the use of a finishing bath containing the textile finishing composition, an acid catalyst, a softening agent, and a diluent.

Unfortunately, many reacted aminoplast resins break down during storage, thus releasing formaldehyde. The formaldehyde release may occur not only throughout the preparation of the fabric but also during garment-making. Further, garments or fabrics treated with aminoplast resins may release additional formaldehyde when stored under humid conditions. Aminoplast resins may also hydrolyze during washing procedures, resulting in a loss of the durable press performance. Additionally, aminoplast resins tend to give fabric a harsher handle, that is, make the fabric feel less soft. As the resins make the fabric feel less soft, the fabric must be treated with additional softeners. Unfortunately, both the aminoplast resins and the softeners tend to make fabric hydrophobic although it is often preferred that the fabric have hydrophilic properties. The aminoplast resins also tend to exhibit a yellowing effect after aqueous washing, and the yellowing effect can often be increased when aditional softener treatments are employed.

Cellulosic fibers have also been cross-linked with formaldehyde to impart durable press properties. For example, the Payet U.S. Pat. Nos. 3,960,482, 3,960,483, 4,067,688 and 4,104,022 disclose durable press processes which comprise impregnating a cellulosic fiber-containing fabric with an aqueous solution comprising a catalyst, and, while the fabric has a moisture content of above 20% by weight, exposing the fabric to formaldehyde vapors and curing under conditions at which formaldehyde reacts with the cellulose. The Payet U.S. Pat. No. 4,108,598 discloses a process which comprises treating cellulosic fiber-containing fabrics with an aqueous solution of formaldehyde and a catalyst, heat curing the treated fabric by introducing the fabric into a heating zone, and gradually increasing the temperature of the heating zone, thereby increasing the temperature of the heated fabric to prevent the loss of an amount of formaldehyde which will reduce the overall extent of curing. The Payet U.S. Pat. No. 5,885,303 also discloses a durable press process for cellulosic fiber-containing fabrics. The process comprises treating the fabric with an aqueous solution of formaldehyde, a catalyst capable of catalyzing the cross-linking reaction between formaldehyde and cellulose, and an effective amount of a silicone elastomer to reduce loss in tear strength in the treated fabric.

Formaldehyde is generally less expensive than aminoplast resins, and formaldehyde treatment of cellulosic fabrics typically results in durable press properties which are more durable than those obtained by aminoplast resins. Formaldehyde treatments can also provide a softer handle to the treated fabric, thus overcoming the need for large amounts of hydrophobic softeners. Generally, in the processes of Payet, formaldehyde is present in a fabric as completely cross-linked formaldehyde, so that once free formaldehyde (i.e. unreacted formaldehyde), is properly removed, for example by washing, the fabric will not continue to liberate formaldehyde.

Cellulose fabric garments are desirable by consumers for a variety of reasons. Cellulose fabrics such as cotton fabrics can often exhibit improved brightness after home laundering as they tend to accumulate brighteners from laundry detergents employed in the laundry process. However, many conventional durable press fabrics do not exhibit such enhanced brightness as the durable press treatments inhibit the accumulation of brighteners on the fabric surface. In fact, as noted above, cellulose fabrics treated with aminoplast resins often tend to exhibit a yellowing effect after home laundering, rather than enhanced brightness.

Accordingly, there is a continuing need to further improve individual characteristics of fabrics and to improve the overall combinations of properties exhibited by such fabrics, and particularly by fabrics containing natural fibers.

### SUMMARY OF THE INVENTION

Accordingly, it is an object of the present invention to obviate problems of the prior art. It is a further object of the present invention to provide improved natural fiber-containing fabrics and methods. It is a related object of this invention to provide formaldehyde crosslinked fabrics which also exhibit improved brightness, for example after laundering which employs detergent containing a brightener component.

These and additional objects are provided by the methods and fabrics of the invention. In one embodiment, the invention is directed to methods for improving the brightness and durable press properties of fabric, which methods comprise treating the fabric with an aqueous solution comprising formaldehyde, catalyst for crosslinking natural fibers of the fabric with cellulose, and silicone elastomer or precursor thereof, and heating the treated fabric to react the formaldehyde with natural fibers in the fabric. In another embodiment, the invention is directed to methods for improving the brightness and shrinkage resistance properties of fabric, which methods comprise treating the fabric with an aqueous solution comprising formaldehyde, catalyst for crosslinking the formaldehyde with natural fibers in the fabric, and silicone elastomer or precursor thereof, and heating the treated fabric to react the formaldehyde with natural fibers in the fabric. In yet additional embodiments, the invention is directed to cellulose fabric having a crosslinked formaldehyde durable press or shrinkage resistance treatment, wherein the fabric has been subjected to laundering with a brightener-containing detergent and exhibits enhanced brightness after the laundering, and to cellulose fabric having a crosslinked formaldehyde durable press or shrinkage resistance treatment and exhibiting enhanced brightness after laundering with a brightener-containing detergent, wherein the fabric does not comprise 100% cotton.

The methods of the invention are advantageous in providing fabrics which exhibit enhanced brightness in combination with other desirable properties, for example durable press properties and/or shrinkage reduction. The enhanced brightness of the fabrics is particularly evident after laundering which employs detergent containing a brightener component.

These and additional aspects, objects and advantages of the invention are more fully described in the detailed description.

### BRIEF DESCRIPTION OF THE DRAWING

The following detailed description of the invention will be more fully understood in view of the drawing in which:

FIG. 1 sets forth reflectance measurements of cellulose fabric prepared according to methods of the present invention and of cellulose fabrics prepared according to comparative methods as described in Example 1; and

FIG. 2 sets forth reflectance measurements of cellulose fabric prepared according to methods of the present invention and of cellulose fabrics prepared according to comparative methods as described in Example 2.

### DETAILED DESCRIPTION OF THE INVENTION

The present invention is directed to methods for improving the brightness of fabric, particularly fabric comprising natural fibers. As used herein, improved brightness is evidenced by an increase in the reflectance of light from the fabric, and preferably by an increase in the reflectance of light of a wavelength in the range of from about 400 to about 510 nm.

The fabrics employed in the present invention preferably comprise natural fibers. As used herein, “individual fiber” refers to a short and/or thin filament, such as short filaments of cotton as obtained from the cotton boll, short filaments of wool as sheared from the sheep, filaments of cellulose or rayon, or the thin filaments of silk obtained from a silkworm cocoon. As used herein, “fibers” is intended to include filaments in any form, including individual filaments, and the filaments present in formed yarns, fabrics and garments.

As used herein, “yarn” refers to a product obtained when fibers are aligned. Yarns are products of substantial length and relatively small cross-section. Yarns may be single ply yarns, that is having one yarn strand, or multiple ply yarns, such as 2-ply yarn which comprises two single yarns twisted together or 3-ply yarn which comprises three yarn strands twisted together. As used herein, “fabrics”generally refer to knitted fabrics, woven fabrics, or non-woven fabrics prepared from yarns or individual fibers, while “garments” generally refer to wearable articles comprising fabrics, including, but not limited to, shirts, blouses, dresses, pants, sweaters and coats. Non-woven fabrics include fabrics such as felt and are composed of a web or batt of fibers bonded by the application of heat and/or pressure and/or entanglement. “Textiles” includes fabrics, yarns, and articles comprising fabrics and/or yarns, such as garments, home goods, including, but not limited to, bed and table linens, draperies and curtains, and upholsteries, and the like.

As used herein, “natural fibers” refer to fibers which are obtained from natural sources, such as cellulosic fibers and protein fibers, or which are formed by the regeneration of or processing of natural occurring fibers and/or products. Natural fibers are not intended to include fibers formed from petroleum products. Natural fibers include fibers formed from cellulose, such as cotton fiber and regenerated cellulose fiber, commonly referred to as rayon, or acetate fiber derived by reacting cellulose with acetic acid and acetic anhydride in the presence of sulfuric acid. As used herein, “natural fibers” are intended to include natural fibers in any form, including individual filaments, and fibers present in yarns, fabrics and other textiles, while “individual natural fibers” is intended to refer to individual natural filaments.

As used herein, “cellulosic fibers” are intended to refer to fibers comprising cellulose, and include, but are not limited to, cotton, linen, flax, rayon, cellulose acetate, cellulose triacetate, hemp and ramie fibers. As used herein, “rayon fibers” is intended to include, but is not limited to, fibers comprising viscose rayon, high wet modulus rayon, cuprammonium rayon, saponified rayon, modal rayon and lyocell rayon. “Protein fibers” are intended to refer to fibers comprising proteins, and include, but are not limited to, wools, such as sheep wool, alpaca, vicuna, mohair, cashmere, guanaco, camel and llama, as well as furs, suedes, and silks.

As used herein, “synthetic fibers” refer to those fibers which are not prepared from naturally occurring filaments and include, but are not limited to, fibers formed of synthetic materials such as polyesters, polyamides such as nylons, polyacrylics, and polyurethanes such as spandex. Synthetic fibers include fibers formed from petroleum products.

Fabrics for use in the present invention preferably comprise natural fibers, which natural fibers may be included in any form, including, but not limited to, in the form of individual fibers (for example in nonwoven fabrics), or in the form of yarns comprising natural fibers, woven or knitted to provide the fabrics. Additionally, the fabrics may be in the form of garments or other textiles comprising natural fibers. The fabrics may further comprise synthetic fibers. Preferably, the fabrics comprise at least about 20% natural fibers. In one embodiment, the fabrics comprise at least about 50% natural fibers such as cotton fibers, rayon fibers or the like. In another embodiment, the fabrics comprise at least about 80% natural fibers such as cotton fibers, rayon fibers or the like, and in a further embodiment, the fibers comprise 100% natural fibers. Fabrics comprising cellulose fibers such as cotton are preferred for use in the present invention.

While not being bound by theory, it is believed that when natural fibers are treated with a composition comprising formaldehyde and a catalyst capable of cross-linking formaldehyde with a natural fiber, a chemical modification of the natural fibers occurs. It is believed that the formaldehyde reacts chemically with the natural fibers to cross-link the individual polymer chains of the natural fibers, and establish the durable press properties and/or dimensional stability, i.e., reduced shrinkage and/or reduced stretching and/or growth. In accordance with the present methods, a silicone elastomer or precursor thereof is included in the formaldehyde treatment and the fabrics surprisingly exhibit enhanced brightness, particularly after laundering with a brightener-containing detergent. The fabrics preferably also exhibit good strength, for example good tear strength.

To provide the crosslinked formaldehyde treatment, the fabric is typically treated with a treatment composition comprising formaldehyde, a catalyst and a silicone elastomer or precursor thereof, followed by drying and/or curing of the treated fabric. Formaldehyde is generally available in an aqueous solution, referred to as formalin, comprising water, about 37% by weight formaldehyde, and generally about 10% to 15% by weight methanol. The amount of formaldehyde in the treatment composition is preferably sufficient to impart a durable press property and/or shrinkage resistance to the fabric. Generally the fabric is treated with at least about 3% by weight formalin, and preferably with from about 3% to about 35% by weight formalin, based on the weight of the fabric. In one embodiment, for example wherein the fabric comprises cotton fibers, the fabric is treated with about 3% to about 8% formalin, based on the weight of the fabric. In another embodiment, for example wherein the fabric comprises rayon fibers, the fabric is treated with from about 10% to about 20% by weight formalin, based on the weight of the fabric. In yet another embodiment, wherein the fabric comprises a 50/50 rayon/polyester blend, the fabric is treated with from about 5% to about 10% by weight formalin, and more preferably about 8% by weight formalin, based on the weight of the fabric. As used herein, “formalin” refers to an aqueous solution comprising 37%, by weight, formaldehyde. As will be apparent to one of skill in the art, formaldehyde solutions comprising levels of formaldehyde other than 37%, by weight, may also be used. Using the above ranges of formalin, the fabric is treated with actual formaldehyde, as opposed to formalin, at a level of from about 1% to about 13%, preferably from about 1% to about 12%, based on the weight of the fabric. Thus, in one embodiment, for example wherein the fabric comprises cotton fibers, the fabric is treated with about 1% to about 3% formaldehyde, as opposed to formalin, based on the weight of the fabric. In another embodiment, for example wherein the fabric comprises rayon fibers, the fabric is treated with from about 4% to about 8% by weight formaldehyde, as opposed to formalin, based on the weight of the fabric. In yet another embodiment, wherein the fabric comprises a 50/50 rayon/polyester blend, the fabric is treated with about 2% to about 4% formaldehyde, as opposed to formalin, based on the weight of the fabric.

Suitable catalysts are those capable of catalyzing a cross-linking reaction between formaldehyde and a natural fiber, and preferably are catalysts capable of catalyzing the cross-linking of formaldehyde with a natural fiber comprising hydroxy groups, such as cellulosic fibers. Catalysts which may be used include mineral acids, organic acids, salts of strong acids, ammonium salts, alkylamine salts, metallic salts and combinations thereof. In one embodiment the catalyst is other than a mineral acid.

Suitable mineral acid catalysts include hydrochloric acid, sulfuric acid, nitric acid, phosphoric acid and boric acid. Suitable organic acids include oxalic acid, tartaric acid, citric acid, malic acid, glycolic acid, methoxyacetic acid, chloroacetic acid, lactic acid, 3-hydroxybutyric acid, methane sulfonic acid, ethane sulfonic acid, hydroxymethane sulfonic acid, benzene sulfonic acid, p-toluene sulfonic acid, cyclopentane tetracarboxylic acid, butane tetracarboxylic acid, tetrahydrofuran-tetracarboxylic acid, nitrilotriacetic acid, and ethylenediaminetetraacetic acid. Suitable salts of strong acids include sodium bisulfate, sodium dihydrogen phosphate and disodium hydrogen phosphate. Suitable ammonium salts include ammonium chloride, ammonium nitrate, ammonium sulfate, ammonium bisulfate, ammonium dihydrogen phosphate and diammonium hydrogen phosphate. Suitable alkanolamine salts include the hydrochloride, nitrate, sulfate, phosphate and sulfamate salts of 2-amino-2-methyl-1-propanol, tris (hydroxymethyl)aminomethane and 2-amino-2-ethyl-1-3-propanediol. Suitable metal salts include aluminum chlorohydroxide, aluminum chloride, aluminum nitrate, aluminum sulfate, magnesium chloride, magnesium nitrate, magnesium sulfate, zinc chloride, zinc nitrate and zinc sulfate, and mixtures thereof.

In one embodiment of the invention, the catalyst is a halide or nitrate salt of zinc or magnesium, and preferably the catalyst is magnesium chloride. An organic acid, such as citric acid, may be used in combination with the halide or nitrate salt of zinc or magnesium. Generally the molar ratio of metal salt to organic acid is from about 5:1 to about 20:1. In one embodiment, the catalyst comprises magnesium chloride and citric acid, while in another embodiment the catalyst comprises magnesium chloride and aluminum chloride.

The fabric is typically treated with an amount of catalyst sufficient to catalyze cross-linking of the natural fibers by the formaldehyde to provide a durable press treatment and/or reduced shrinkage, for example reduced shrinkage upon aqueous laundering. In one embodiment, the catalyst may be employed in an amount sufficient to provide a formaldehyde:catalyst weight ratio of from about 10:1 to about 1:10, and preferably from about 5:1 to about 1:5.

The formaldehyde treatment composition may comprise, by weight, up to about 12% of a catalyst solution, and preferably from about 1% to about 9% of a catalyst solution. Generally the catalyst solution comprises from about 20% to about 50%, by weight catalyst. In one embodiment, for example wherein the fabric comprises cotton fibers, the treatment solution comprises from about 2 to about 4% by weight of a catalyst solution comprising about 30% by weight catalyst, and in another embodiment, for example wherein the fabric comprises rayon fibers, the treatment solution comprises from about 6% to about 8% by weight of a catalyst solution comprising about 30% by weight catalyst. In yet a further embodiment, the catalyst solution comprises about 40%, by weight, magnesium chloride, for a final magnesium chloride level of up to about 5%, by weight of the treatment solution. Suitable catalyst solutions include FREECAT® LF (magnesium chloride and citric acid) and FREECAT® No. 9 (aluminum chloride and magnesium chloride), commercially available from B. F. Goodrich.

The formaldehyde treatment composition typically comprises a liquid carrier, preferably water, although, as noted above, the formalin used to prepare the treatment composition may comprise small amounts of organic solvents such as methanol or the like. In one embodiment, the treatment composition is free of any organic solvents other than that present in the formalin or the catalyst solution. In another embodiment, the carrier may comprise pentamethylcyclosiloxane.

According to the present methods, a silicone elastomer or precursor thereof is included in the formaldehyde-containing treatment composition with which the fabric is treated. Thus, the formaldehyde treatment composition comprises formaldehyde, catalyst and silicone elastomer or a precursor thereof. It has been surprisingly discovered that the combination of a silicone elastomer or precursor thereof and the formaldehyde-containing treatment composition improves the brightness of the fabric, particularly after aqueous laundering of the fabric in a detergent which contains a brightener component, while also providing good durable press and/or shrinkage resistance properties. The silicone elastomer may also be effective to reduce the loss in tear strength that typically occurs during formaldehyde cross-linking of fibers.

Various silicone elastomers are known in the art and are suitable for use in the methods and fabrics of the invention. In one embodiment, the silicone elastomer is a polysiloxane. Similarly, the silicone elastomer precursor which forms an elastomer upon curing, typically by self curing, may be a polysiloxane. Elastomers are polymers which are capable of being stretched with relatively little applied force, and which return to the unstretched length when the force is released. Silicone elastomers have a backbone made of silicon and oxygen with organic substituents attached to silicon atoms, with a number n of repeating units of the general formula:

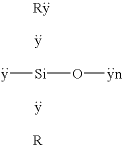

The groups R and Rÿ are each independently selected from lower alkyls, preferably C₁-C₃ alkyls, phenyl, or lower alkyls or phenyls comprising a group reactive to cellulose, such as hydroxy groups, halogen atoms, for example, fluoride, or amino groups. Suitable elastomers include those disclosed in U.S. Pat. No. 5,885,303, incorporated herein by reference.

A preferred silicone elastomer or precursor composition comprises up to about 60%, by weight, silicone solids. In one embodiment, the silicone elastomer or precursor composition comprises from about 20% to about 60%, preferably from about 30% to about 60%, by weight of silicone solids, while in another embodiment the silicone elastomer or precursor composition comprises from about 20% to about 30% by weight of silicone solids. Suitable silicone elastomer precursors include a dimethyl silicone emulsion containing from about 30% to about 60%, by weight, silicone solids, commercially available as SM2112 from General Electric. Another suitable commercially available elastomer precursor is Sedgesoft ELS from Sedgefield Specialties, containing from about 24% to about 26%, by weight, silicone solids.

When the silicone elastomer or precursor thereof is applied to the fabric with a liquid formaldehyde treatment composition, the liquid treatment composition may comprise up to about 10%, preferably from about 1% to about 5%, more preferably from about 1% to about 3%, by weight of the elastomer or precursor solids. In one embodiment, the treatment composition comprises from about 1% to about 3%, preferably from about 1.5% to 3%, by weight silicone solids, while in another embodiment, the composition comprises from about 1% to about 1.5% by weight silicone solids.

The formaldehyde treatment composition may be applied to the fabric in accordance with any of the conventional techniques known in the art. In one embodiment, the treatment composition may be applied to the fabric by saturating the fabric in a trough and squeezing the saturated fabric through pressure rollers to achieve a uniform application (padding process). As used herein “wet pick-up” refers to the amount of treatment composition applied to and/or absorbed into the fabric based on the original weight of the fabric. “Original weight of the fabric” or simply “weight of the fabric” refers to the weight of the fabric prior to its contact with the treatment composition. For example, 50% pick-up means that the fabric picks up an amount of treatment solution equal to 50% of the fabric's original weight. Preferably the wet pick-up is at least 20%, preferably from about 50% to 100%, more preferably from about 65% to about 80%, by weight of the fabric.

Other application techniques which may be employed include kiss roll application, engraved roll application, printing, foam finishing, vacuum extraction, spray application or any process known in the art. Generally theses techniques provide lower wet pick-up than the padding process. The concentration of the chemicals in the solution may be adjusted to provide the desired amount of chemicals on the original weight of the fabric (OWF).

In a preferred embodiment, the formaldehyde treatment composition is applied in an amount to insure a moisture content of more than 20% by weight, preferably more than 30% by weight, on the fabric before curing. Optionally, a wetting agent may be included in the treatment composition to facilitate obtaining the desired moisture content. Nonionic wetting agents are preferred.

Once the treatment composition has been applied to the fabric, the fabric is typically heated for a time and at a temperature sufficient for the cross-linking of the natural fibers with the formaldehyde. For example, the fabric may be heated at a temperature greater than about 250 ÿF, preferably from about 250 ÿF to about 350 ÿF, in an oven for a period of from about 15 seconds to about 15 minutes, preferably from about 45 seconds to about 3 minutes, to react the formaldehyde with the natural fibers in the fabric and affect crosslinking of the formaldehyde and natural fibers to provide durable press and/or shrinkage resistance effects. There is an inverse relationship between curing temperature and curing time, that is, the higher the temperature of curing, the shorter the dwell time in the oven; conversely, the lower the curing temperature, the longer the dwell time in the oven.

The methods for improving the brightness of fabrics according to the present invention are particularly adapted for fabrics intended for laundering, particularly aqueous laundering, wherein detergent including one or more brightener components is employed. As used herein, brightener components include one or more optical brighteners or whiteners. Typically, the terms “optical brighteners” and “whiteners” are used interchangeably and are taken to mean organic compounds which absorb the invisible ultraviolet (UV) portion of the daylight spectrum and convert this energy into the longer-wavelength visible portion of the spectra. Optical brighteners mask the yellow cast which can develop on the surface of fabric fiber, and various types of brighteners/whiteners are known in the art and are suitable for use herein. Fluorescent whitening is based on the addition of light by fluorescence, whereas older methods such as “blueing” are achieved by subtraction of light by the addition of blue or blue-violet dyes to textiles. Commercial optical brighteners include, but are not necessarily limited to, derivatives of stilbene, pyrazoline, coumarin, carboxylic acid, methinecyanines, dibenzothiophene-5,5-dioxide, azoles, 5- and 6-membered-ring heterocycles, and other miscellaneous agents. Examples of such brighteners are disclosed in “The Production and Application of Fluorescent Brightening Agents,” M. Zahradnik, published by John Wiley & Sons, New York (1982).

Examples of optical brighteners are those identified in the Wixon U.S. Pat. No. 4,790,856. These brighteners include the PHORWHITE series of brighteners from Verona. Other brighteners disclosed in this reference include: Tinopal UNPA, Tinopal CBS and Tinopal 5BM; available from Ciba-Geigy; Arctic White CC and Arctic White CWD, the 2-(4-styryl-phenyl)-2H-naptho[1,2-d]triazoles; 4,4′-bis-(1,2,3-triazol-2-yl)-stilbenes; 4,4′-bis(styryl)bisphenyls; and the amino-coumarins. Specific examples of these brighteners include 4-methyl-7-diethyl-amino conmarin; 1,2-bis(benzimidazol-2-yl)ethylene; 1,3-diphenyl-pyrazolines; 2,5-bis(benzoxazol-2-yl)thiophene; 2-styryl-naphth[1,2-d]oxazole; and 2-(stilben-4-yl)-2H-naptho[1,2-d]triazole. Additional known brighteners are disclosed in the Hamilton U.S. Pat. No. 3,646,015.

In another embodiment, the present invention comprises methods for improving the brightness of fabric, wherein the silicone elastomer may be included in the treated fabric by means of a separate treatment step before or after the formaldehyde crosslinking treatment. Additionally, if the silicone elastomer or precursor thereof is applied to the fabric subsequent to treatment with the formaldehyde crosslinking composition, the silicone elastomer precursor thereof may be applied prior to or subsequent to the heating step which is employed to affect curing of the formaldehyde with the natural fibers of the fabric, although application prior to heating is preferred. The applied silicone elastomer or precursor thereof may be dried, with self curing of the precursor being affected thereby.

In processes in accordance with the present invention, unreacted formaldehyde remaining on the fabric is removed during subsequent processing of the fabric. Generally, the final substrate will comprise less than about 300 ppm formaldehyde, preferably less than about 200 ppm formaldehyde, more preferably less than about 100 ppm formaldehyde, and even more preferably less than about 50 ppm formaldehyde, as measured according to AATCC Test Method 112-1993.

Some polysiloxanes, generally referred to as silicone oils, have a liquid form, are not elastomeric and do not self-crosslink. Silicone oils include, for example, non-reactive linear polydimethyl siloxanes, that is, siloxanes which are not capable of further reaction with other silicones and are not capable of a self curing reaction. Silicone oils have a tendency to produce non-removable spots on fabrics. In contrast, the silicone elastomers used in the present invention generally do not produce such spots. Although the fabrics or treatment compositions may comprise silicone oil, in one embodiment, the fabrics and treatment compositions are substantially free of, and preferably are free of, silicone oil. As used herein, substantially free of silicone oils means the treatment compositions and fabrics comprise less than 1%, by weight, silicone oil.

Thermosetting resins used to impart durable press properties to fabrics are generally aminoplast resins which are the products of the reaction of formaldehyde with compounds such as urea, thiourea, ethylene urea, dihydroxyethylene urea and melamines. As used herein “aminoplast resins” is intended to include N-methylolamide cross-linking agents such as dimethylol dihydroxyethylene urea, dimethylol urea, dimethylolethylene urea, dimethylol propylene urea, dimethylol methyl carbamate, dimethylol n-propylcarbamate, dimethylol isopropylcarbamate trimethylolated melamine, and tris(methoxymethol) melamine. Preferably, the fabrics, methods and formaldehyde treatment compositions of the invention are substantially free of, and more preferably are free of, aminoplast resins and N-methylol cross-linking agents. As used herein, “substantially free” of aminoplast resins and N-methylol cross-linking agents is intended to mean the fabrics and treatment solutions comprise less than about 0.5%, by weight, aminoplast resin or methylol cross-linking agent.

Prior to treatment with the formaldehyde composition and silicone elastomer or precursor thereof, the fabric may optionally be prepared using any fiber, yarn, or textile pre-treatment preparation techniques known in the art. Suitable preparation techniques include brushing, singeing, desizing, scouring, mercerizing, and bleaching. For example, fabric may be treated by brushing which refers to the use of mechanical means for raising surface fibers which will be removed during singeing. The fabric may be then be singed using a flame to burn away fibers and fuzz protruding from the fabric surface. Textiles may be desized, which refers to the removal of sizing chemicals such as starch and/or polyvinyl alcohol, that are put on yarns prior to weaving to protect individual yarns. The fabrics may be scoured, which refers to the process of removing natural impurities such as oils, fats and waxes and synthetic impurities such as mill grease from fabrics. Mercerization refers to the application of high concentrations of sodium hydroxide to a fabric to alter the morphology of fibers, particularly cotton fibers. Fabrics may be mercerized to improve fabric stability and luster. Finally, bleaching refers to the process of destroying any natural color bodies within the natural fiber. A typical bleaching agent is hydrogen peroxide.

The various preparation techniques are optional and dependent upon the desired final product. For example, when the final fabric is to be dyed a dark color, there may be no need to bleach the substrate. Similarly, there may be no need to desize a knit which was prepared without using any sizing agents, and no need to separately scour knits and woven textiles as the scouring may be done during bleaching.

In accordance with a further embodiment of the invention, cellulose fabrics having a crosslinked formaldehyde durable press or shrinkage resistance treatment, wherein the fabric has been subjected to laundering with a brightener-containing detergent and exhibits enhanced brightness after the laundering, are provided. In various embodiments, the cellulose fabric comprises greater than about 50% cotton fibers, greater than about 80% cotton fibers, about 100% cotton fibers, greater than about 50% rayon fibers, greater than about 80% rayon fibers, or about 100% rayon fibers. The fabric after laundering with a brightener-containing detergent exhibits improved brightness as compared with the fabric prior to such laundering. It is preferred that the fabric exhibit good durable press, for example a DP (durable press) rating of at least about 3.0, preferably at least about 3.25, and more preferably at least about 3.5, as measured according to AATCC Test Method 124-1996, after one aqueous washing, and preferably after five aqueous washings, and/or good shrinkage resistance, for example a length shrinkage and a width shrinkage of less than about 10% each, preferably less than about 5% each, more preferably less than about 4% each, and even more preferably less than about 2% each, and in specific embodiments less than about 1%, as measured according to AATCC Test Method 135-1995, after one machine washing, and preferably after five aqueous washings. Shrinkage resistance may also be measured according to AATCC Test Method 150-1995. In further preferred embodiments, the fabrics exhibit good filling tensile and tear strengths, for example of at least about 25 pounds and at least about 24 ounces, respectively, as measured according to ASTM D-5035-95 for tensile strength and ASTMD-2261-96 for tear strength.

In another embodiment, cellulose fabrics having a crosslinked formaldehyde treatment and exhibiting enhanced brightness after home laundering are obtained. In one embodiment, the fabric does not comprise 100% cotton. These fabrics may comprise greater than about 20% cotton fibers, greater than about 50% cotton fibers, greater than about 80% cotton fibers, greater than about 20% rayon fibers, greater than about 50% rayon fibers, greater than about 80% rayon fibers, or about 100% rayon fibers.

The following examples are set forth to demonstrate the improved brightness which is obtained by the methods of the present invention. Throughout the examples and the present specification, parts and percentages are by weight unless otherwise specified. The following examples are illustrative only and are not intended to limit the scope of the methods and fabrics of the invention as defined by the claims.

### EXAMPLE 1

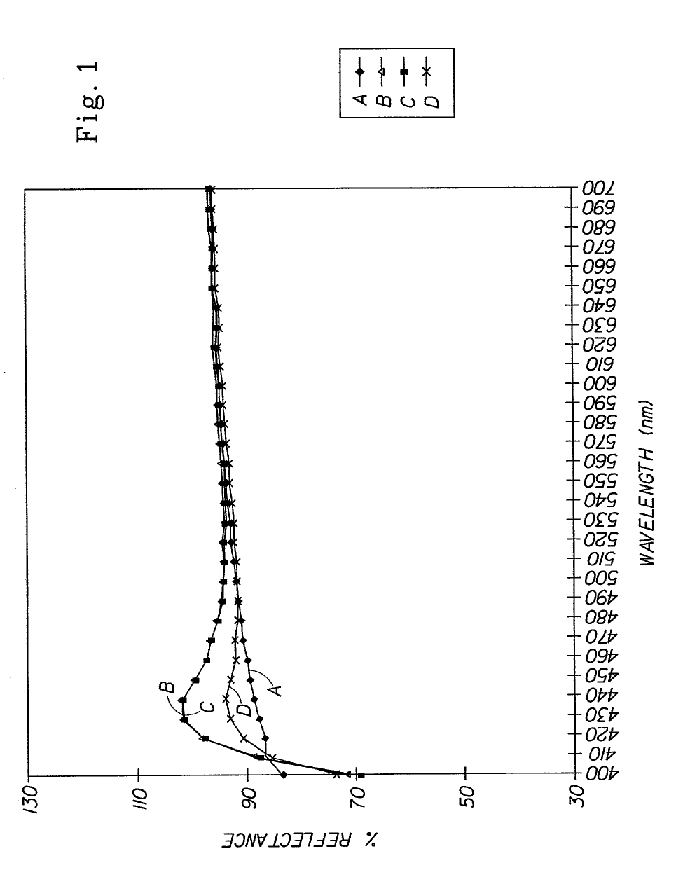

In this example, the reflectance properties of four different fabrics are measured using a Hunter Miniscan XE to measure whiteness/brightness. The light source is D65 and a ten degree angle of observation is employed. The reflectance of each fabric is set forth in FIG. 1.

In FIG. 1, Curve A represented by diamond shaped data points indicates the reflectance of a 100% cotton shirting fabric which does not contain any formaldehyde crosslinking or other durable press treatment, which does not contain any optical brightener from the fabric manufacturing process, and which has not been subjected to any detergent wash process. Curve B represented by the triangular shaped data points indicates the reflectance of a 100% cotton shirting fabric which does not contain any formaldehyde crosslinking or other durable press treatment and which is subjected to one detergent wash process with a detergent containing a brightener (Liquid Tide® Free). Curve C represented by the square data points indicates the reflectance of a 100% cotton shirting fabric in which brightness is improved by a method according to the invention comprising treatment with a composition of formaldehyde and catalyst and further comprising a silicone elastomer precursor. Generally, the fabric is treated with an aqueous solution comprising about 8% formalin, about 2% catalyst solution (30% by weight catalyst) and about 3% silicone elastomer precursor (solids basis) comprising GE SM2112. The solution also contains about 1% of a wetting agent, Trycol 5953. The fabric is subjected to heat curing subsequent to application of the formaldehyde-catalyst-silicone elastomer precursor treatment composition as it passes through an oven at about 350 ÿF and at a speed of about 28 yard/min. The fabric is also subjected to one detergent wash process using the described detergent containing a brightener component. Finally, Curve D represented by the cross shaped data points (X) represents the reflectance of a 100% cotton shirting fabric which is provided with a conventional aminoplast resin durable press treatment. Specifically, the fabric is treated with a solution comprising about 8% DMDHEU, about 2% catalyst, about 2% polyethylene emulsion (Atebin PHD from Hoehme Filatex), about 2% of a silicone elastomer (Glosil ECR from Glotex Chemical) and about 1% opf the wetting agent Trycol 5953. The fabric is then subjected to heat curing at about 350 ÿF by passing through an oven at a speed of about 28 yards/min. The fabric is subjected to one detergent wash process using the described detergent containing a brightener component.

The results set forth in FIG. 1 demonstrate that the untreated, nonlaundered fabric exhibit the lowest reflectance (Curve A), evidencing the lowest fabric brightness. On the other hand, the fabric treated according to the methods of the present invention (Curve C) exhibits improved brightness equivalent to that of the untreated fabric after one detergent wash process (Curve B). This is surprising as conventional durable press treatments typically result in reduced brightness as the durable press treatment inhibits the fabric from picking up or attracting brighteners from a solution of a brightener-containing detergent composition. The reduced brightness obtained according to conventional durable press treatments is exhibited by the fabric treated with the conventional aminoplast resin durable press composition (Curve D).

### EXAMPLE 2

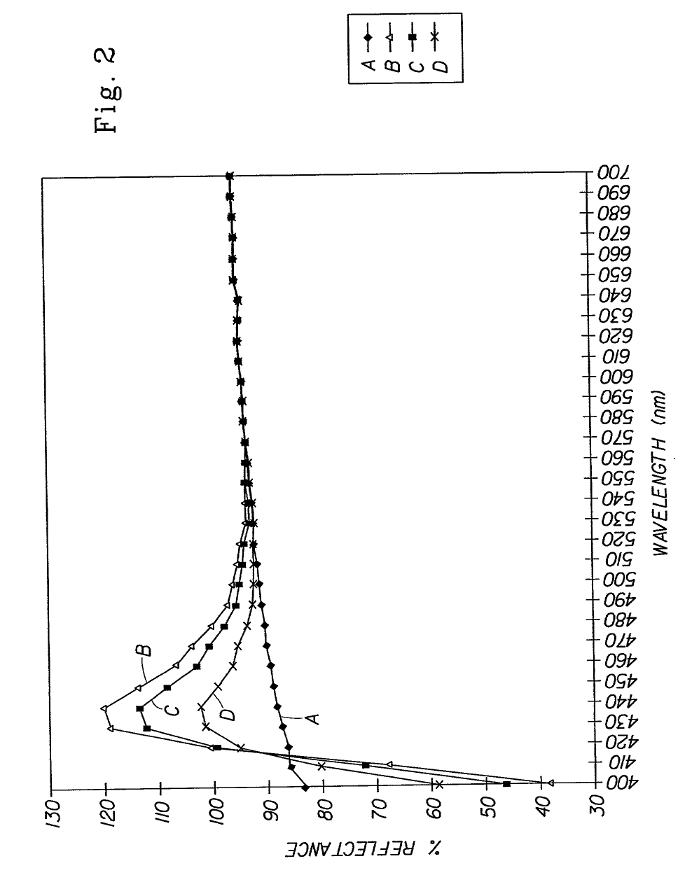

The fabrics from Example 1 are subjected to 25 total detergent wash cycles employing the described detergent containing a brightener component, after which the reflectance of the fabrics is measured and again compared with an untreated fabric which is not subjected to any detergent wash processing. The results of the reflectance measurements are set forth in FIG. 2 wherein like curves and data points as described in Example 1 are used to represent the reflectance of the respective fabrics. As is evident from FIG. 2, the improved brightness which is obtained according to the methods of the present invention (Curve C) is particularly evident after multiple detergent wash cycles, particularly as compared with fabrics treated with a conventional aminoplast resin durable press treatment (Curve D).

The examples and specific embodiments set forth herein are for illustrative purposes only and are not intended to limit the scope of the methods and fabrics of the invention. Additional methods and fabrics within the scope of the claimed invention will be apparent to one of ordinary skill in the art in view of the teachings set forth herein.

What is claimed is:

1. A method for improving the brightness and durable press properties of fabric, comprising treating the fabric with an aqueous solution comprising formaldehyde, catalyst for crosslinking the formaldehyde with natural fibers in the fabric, and silicone elastomer or precursor thereof, and heating the treated fabric to react the formaldehyde with natural fibers in the fabric.

2. A method according to claim 1, wherein the fabric comprises greater than about 50 percent cellulose fibers.

3. A method according to claim 2, wherein the fabric comprises greater than about 50 percent cotton fibers.

4. A method according to claim 2, wherein the fabric comprises about 100 percent cotton fibers.

5. A method according to claim 1, wherein the aqueous solution comprises silicone elastomer.

6. A method according to claim 1, wherein the aqueous solution comprises silicone elastomer precursor.

7. A method according to claim 1, wherein the fabric brightness improves after laundering of the fabric with a brightener-containing detergent.

8. A method for improving the brightness and shrinkage resistance properties of fabric, comprising treating the fabric with an aqueous solution comprising formaldehyde, catalyst for crosslinking the formaldehyde with natural fibers in the fabric, and silicone elastomer or precursor thereof, and heating the treated fabric to react the formaldehyde with natural fibers in the fabric.

9. A method according to claim 8, wherein the fabric comprises greater than about 50 percent cellulose fibers.

10. A method according to claim 9, wherein the fabric comprises greater than about 50 percent cotton fibers.

11. A method according to claim 9, wherein the fabric comprises about 100 percent cotton fibers.

12. A method for improving the brightness and durable press properties of cellulose fabric, comprising treating the fabric with an aqueous solution comprising formaldehyde, catalyst for crosslinking the formaldehyde with cellulose, and silicone elastomer or precursor thereof, and heating the treated fabric to react the formaldehyde with cellulose in the fabric.

13. A method for improving the brightness and shrinkage resistance properties of cellulose fabric, comprising treating the fabric with an aqueous solution comprising formaldehyde, catalyst for crosslinking the formaldehyde with cellulose, and silicone elastomer or precursor thereof, and heating the treated fabric to react the formaldehyde with cellulose in the fabric.

14. Cellulose fabric having a crosslinked formaldehyde durable press or shrinkage resistance treatment, wherein the fabric has been subjected to laundering with a brightener-containing detergent and exhibits enhanced brightness after the laundering.

15. Cellulose fabric according to claim 14, comprising greater than 50% cotton fibers.

16. Cellulose fabric according to claim 14, comprising about 100% cotton fibers.

17. Cellulose fabric according to claim 14, provided with a silicone elastomer.

18. Cellulose fabric according to claim 17, having a durable press rating of at least about 3.0 after one laundering.

19. Cellulose fabric according to claim 18, exhibiting a length shrinkage and a width shrinkage of less than about 5% each.

20. Cellulose fabric having a crosslinked formaldehyde durable press or shrinkage resistance treatment and exhibiting enhanced brightness after laundering with a brightener-containing detergent, wherein the fabric does not comprise 100% cotton.

21. A method for improving the brightness and durable press or shrinkage resistance properties of fabric, comprising treating the fabric with an aqueous solution comprising formaldehyde and catalyst for crosslinking the formaldehyde with natural fibers in the fabric, treating the fabric with silicone elastomer or precursor thereof, and heating the treated fabric to react the formaldehyde with natural fibers in the fabric.
